(19) United States
(12) Patent Application Publication
(10) Pub. No.: US 2025/0180431 A1
(43) Pub. Date: Jun. 5, 2025

(54) A METHOD OF EVALUATING SEAL PROPERTIES OF AN ELASTOMERIC SEAL OR PLASTIC SEAL ON A VALVE ELEMENT OR A VALVE SEAT AND A HYDRAULIC ARRANGEMENT

(71) Applicant: HYDRACT A/S, Holstebro (DK)

(72) Inventors: Robert COLLINS, Holstebro (DK); Peter ESPERSEN, Holstebro (DK)

(21) Appl. No.: 18/843,255

(22) PCT Filed: Mar. 2, 2023
(86) PCT No.: PCT/EP2023/055286

§ 371 Date: Sep. 1, 2024

(30) Foreign Application Priority Data
Mar. 2, 2022 (DK) PA202270084

(51) Int. Cl. G01M 13/005; F16K 37/00; G01M 13/003

(52) U.S. Cl. CPC G01M 13/005; F16K 37/0083; G01M 13/003

(57) ABSTRACT

A method of evaluating seal properties of an elastomeric or plastic seal on a valve element or a valve seat is provided, which valve element operated by a hydraulic arrangement, wherein the valve element is operated between—a contact state, where the valve element is in contact with the valve seat, and—a non-contact state, where the valve element is not in contact with the valve seat, wherein the method includes: changing state from a non-contact state to a contact state, —measuring a valve initial contact position at contact with the valve seat, where the elastomeric seal or the plastic seal makes contact with the valve element or the valve seat; —storing the valve initial contact position on a computer-readable medium, —repeating the steps of changing, measuring and storing, and—evaluating seal properties of the elastomeric seal or plastic seal as a function of the stored valve initial contact positions.

### CROSS-REFERENCE TO RELATED APPLICATIONS

This application is a national stage of PCT Application No. PCT/EP2023/055286, having a filing date of Mar. 2, 2023, which is based DK Application No. PA202270084, having a filing date of Mar. 2, 2022, the entire contents both of which are hereby incorporated by reference.

### FIELD OF TECHNOLOGY

The following relates to method of evaluating seal properties of an elastomeric seal or plastic seal on a valve element or a valve seat such that deterioration or wear of an elastomeric seal or a plastic seal is identified before failure of the valve.

The following also relates to a hydraulic arrangement capable of measuring seal properties of an elastomeric seal or plastic seal on a valve element or a valve seat and embodiments of the invention relate to a valve system comprising one or more hydraulic arrangements, wherein the valve system is configured to survey seal properties of the one or more valves.

### BACKGROUND

It is well known that seal properties of a seal for a hydraulic valve will change over time and that the seal properties deteriorate and at some point, the seal should be replaced in order to prevent failure of the valve or damage of the valve.

The deterioration may be swelling of the elastomeric seal or the plastic seal, or shrinkage of the elastomeric seal or the plastic seal, or abrasion of the elastomeric seal or the plastic seal. The deterioration will typically happen over months or years depending on the use of the valve and/or type of seal. It is presently difficult to predict when the seal must be replaced and, in most cases, it requires a manual maintenance, where the seal is checked by a user. This will cause operation downtime of the valve, which will reduce production.

Thus, there is a need for a method and a hydraulic arrangement capable of evaluating the seal properties of the seal. There is an even greater need for a method and a hydraulic arrangement capable of evaluating the seal properties of the seal during normal operation of the hydraulic arrangement.

### SUMMARY

An aspect relates to a method and a hydraulic arrangement capable of evaluating the seal properties of the seal.

An aspect of embodiments of the invention are achieved by a method of evaluating seal properties of an elastomeric seal or a plastic seal on a valve element or a valve seat, which valve element being operated by a hydraulic arrangement. The valve element is operated between
a contact state, where the valve element is in contact with the valve seat, and
a non-contact state, where the valve element is not in contact with the valve seat.

In embodiments, the method comprises steps of
changing state from a non-contact state to a contact state,
measuring a valve initial contact position at contact with the valve seat, where the elastomeric seal or the plastic seal makes contact with the valve element or the valve seat;
storing the valve initial contact position on a computer-readable medium,
repeating the steps of changing, measuring and storing, and
evaluating seal properties of the elastomeric seal or plastic seal as a function of the stored valve initial contact positions.

In embodiments, the method is capable of evaluating seal properties by measuring the valve initial contact position a repeated number of times as this enables detecting changes in the valve initial contact position over time. Thus, in embodiments the method enables a user or a system to estimate when the seal should be replaced.

In case of swelling of the seal, the valve initial contact position will change over time in one direction. In case of shrinkage of the seal or abrasion of the seal, the valve initial contact position will change over time in a different direction.

Throughout this patent application, when referring to the seal, the seal can be an elastomeric seal or a plastic seal.

The shape of the seal may have many different embodiments as the seal will be chosen depending on of the specific embodiment of the valve element and the valve seat complementary to the valve element. The seal may be positioned on either the valve element or the valve seat. If the seal is positioned on the valve element, then the valve initial contact position is the position where the seal makes contact with the valve seat as the seal is seen as being part of the valve element, while if the seal is positioned on the valve seat, then the valve initial contact position is the position where the valve element makes contact with the seal as the seal is seen as being part of the valve seat. The two possibilities are equivalent.

The valve element is operated between the contact state, where the valve element is in contact with the valve seat, and the non-contact state, where the valve element is not in contact with the valve seat. In embodiments, the method collects data when the valve element changes state to the contact state by measuring the valve initial contact position being where there is first contact between the valve element and the valve seat.

The valve initial contact position can be measured as the position where the hydraulic arrangement will experience a higher resistance to movement of the valve element and as a result the velocity of the valve element will change.

The valve initial contact position is stored on a computer-readable medium as the method must be repeated over long periods of time in order to evaluate seal properties of the elastomeric seal or plastic seal. The computer-readable medium may be a local computer-readable medium or a server as long as the stored data is accessible when performing the step of evaluating the seal properties.

In embodiments, the method will be performed over long periods of time such as weeks, months, or years, and if the state of the valve element is changed several times a minute or even per day, then the method does not require data from each change of state in order to perform the step of evaluating the seal properties.

Thus, there may also be a step of replacing the elastomeric seal or the plastic seal as a function of the seal properties.

In an aspect, the step of measuring may include a valve velocity from contact with the valve seat to a stationary position of the valve element, and the step of storing may include storing the valve velocity on a computer-readable medium, and the step of evaluating may include evaluating seal properties of the elastomeric seal or the plastic seal as a function of the stored valve velocities.

The swelling or shrinkage of the elastomeric seal will cause other material changes to the elastomeric seal. Swelling of the elastomeric seal will typically cause the elastomeric seal to become softer. Shrinkage will typically cause the elastomeric seal to become harder. As a result, the valve velocity from contact with the valve seat to a stationary position will have a different velocity profile compared to the elastomeric seal before swelling or shrinkage. Thus, the valve velocity correlates to the seal properties.

In embodiments, the method may use an external clock for providing time or the hydraulic arrangement may comprise a clock for providing time such that the velocity can be calculated based on position data.

In an aspect, embodiments of the method may be performed during normal operation of the hydraulic arrangement.

Thus, embodiments of the method can be performed while the hydraulic arrangement is operated under normal operation. Thus, downtime of the hydraulic arrangement can be reduced significantly compared to the conventional art as the elastomeric seal or the plastic seal is evaluated based on data retrieved during normal operation.

In an aspect, the step of evaluating may include a step of predicting remaining operating time until failure of the elastomeric seal or plastic seal.

The steps of embodiments of the method are repeated over time and as such the deterioration rate can be estimated and a remaining operating time until failure of the elastomeric seal or plastic seal can be estimated continuously and during normal operation. Thereby, predictive maintenance is enabled.

The steps of evaluating and predicting may further be performed as a function of collected data from a plurality of other seals in other hydraulic arrangements.

Machine learning may further be used during the steps of evaluating and predicting.

In embodiments, the method may further perform a step of sending a warning to a user or server as a function of the remaining operating time until failure of the elastomeric seal or plastic seal.

In an aspect, a magnet may be mechanically linked to the valve element, and wherein actuation of the valve element causes actuation of the magnet along a magnet path.

The step of measuring may comprise
a step of measuring a magnetic field along the magnet path; and
a step of calculating the valve initial contact position as a function of the magnetic field along the magnet path.

The actuation of the magnet and the valve element may be directly correlated where a 1 cm linear movement of the valve results in a 1 cm linear movement of the magnet. This would be the case where the magnet is connected to a piston shaft actuating the valve element.

However, the hydraulic arrangement may comprise a linear actuator driving a rotary actuator driving a butterfly valve, which butterfly valve includes a valve element and valve seat.

In this case, the magnet may be connected to the linear actuator and thus the movement and position of the magnet does not correlate directly to the movement and the position and/or velocity of the valve element, however this can be calculated using basic mathematics. The reverse situation may also be possible.

Thus, by measuring the magnetic field along the magnet path, the position of the valve can be calculated and thus the valve initial contact position as a function of the magnetic field along the magnet path can likewise be calculated.

In an aspect, the step of calculating may include calculating the valve velocity as a function of the magnetic field along the magnet path.

Thereby, the solution can detect both the valve initial contact position and the valve velocity, and the valve initial contact position will be positioned where the valve velocity begins to change from a constant value.

The valve velocity may be valve angular velocity.

An aspect of embodiments of the invention is achieved by a hydraulic arrangement comprising a valve with a valve element and a complementary valve seat, and an elastomeric seal or a plastic seal on the valve element or the valve seat.

The valve element is operated between
a contact state, where the valve element is in contact with a valve seat, and
a non-contact state, where valve element is not in contact with the valve seat.

The hydraulic arrangement further comprises
a position detection means adapted for measuring a position of the valve element relative to the valve seat including a valve initial contact position, where the elastomeric seal or the plastic seal makes contact with the valve element or the valve seat.

The hydraulic arrangement further comprises
an evaluation module comprising a computer-readable medium for storing at least the valve initial contact position and means for evaluating seal properties of the elastomer as a function of the stored valve initial contact positions, and/or
a communication module adapted for wired or wireless communication with an external evaluation module adapted for evaluating seal properties of the elastomeric seal or the plastic seal as a function of the stored valve initial contact positions.

The shape of the seal may have many different embodiments as the seal will be chosen depending on of the specific embodiment of the valve element and the valve seat complementary to the valve element. The seal may be positioned on either the valve element or the valve seat. If the seal is positioned on the valve element, then the valve initial contact position is the position where the seal makes contact with the valve seat as the seal is seen as being part of the valve element, while if the seal is positioned on the valve seat, then the valve initial contact position is the position where the valve element contacts the seal as the seal is seen as being part of the valve seat. The two possibilities are equivalent.

The valve element is operated between the contact state, where the valve element is in contact with the valve seat, and the non-contact state, where the valve element is not in contact with the valve seat. In embodiments, the method collects data when the valve element changes state to the contact state by measuring the valve initial contact position being where the valve element and valve seat first make contact.

The valve initial contact position can be measured by the position detection means as the position where hydraulic arrangement will experience a higher resistance to movement of the valve element and as a result the velocity of the valve element will change.

The valve initial contact position is stored on the computer-readable medium of the evaluation module and/or sent by the communication module to the external evaluation module such that data can be collected over time, wherein the data at least include the valve initial contact position.

This will enable a step of evaluating seal properties of the elastomeric seal or plastic seal as a function of the stored valve initial contact position.

The external evaluation module may collect data from a plurality of hydraulic arrangements and the data from the plurality of hydraulic arrangements may be used during the step of evaluating seal properties of a specific elastomeric seal or a specific plastic seal.

The external evaluation module may use machine learning.

In an embodiment, the position detection means may comprise a potentiometer or resistive measurement. The position detection means comprises an electrical contact mechanical linked to the valve element such that the electrical contact is actuated when the valve element is actuated. The electrical contact is in contact with a resistive track such that a measured output is related to a positional change of the electrical contact and thus the valve element. In another embodiment, the resistive track is actuated when the valve element is actuated however the resulting output will be the same.

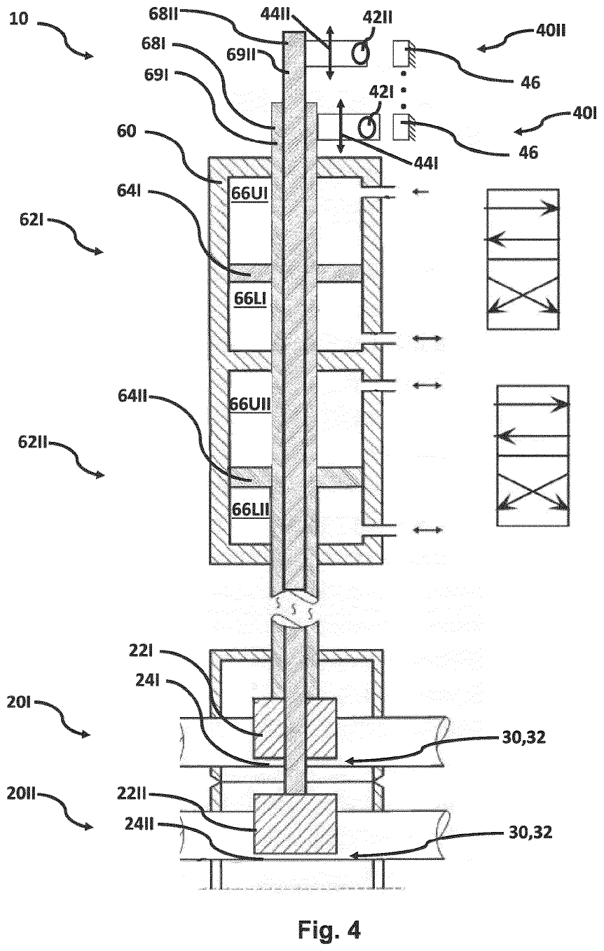

In an embodiment, the position detection means may comprise a ferrous material mechanical linked to the valve element, such that the ferrous materials when the valve element is actuated, and one or more inductive sensors positioned to sense the ferrous materials passing near to the one or more inductive sensors. This embodiment could be used in the embodiments disclosed in FIGS. 4-7 or the other mentioned embodiments by replacing a magnet with the ferrous material and by replacing one or more magnetic sensors with the one or more inductive sensors.

In an embodiment, the position detection means may comprise a light source configured for sending a light towards a piston shaft and a light detection sensor is configured for detecting the light, wherein a valve element position and valve velocity, is calculated based on the time of flight of the light. The light source may send light pulses. The light source may be a laser sending light pulses. The light may be directed towards a top of a piston shaft mechanically linked to the valve element, which top will be actuated when the valve element is actuated. The valve element position or change in position can be calculated based on the change of the time of flight of the light.

In an embodiment, the position detection means may comprise a rotary encoder being mechanically linked to the valve element, wherein angular rotation a rotary shaft of the rotary encoder can be used to determine position, direction and valve velocity. The rotary encoder may be an incremental type or an absolute type.

In an aspect, the position detection means may be further configured for measuring a valve velocity from contact with the valve seat to a stationary position of the valve element.

The swelling or shrinkage of the elastomeric seal will cause other material changes to the elastomeric seal. Swelling of the elastomeric seal will typically cause the elastomeric seal to become softer, while shrinkage will typically cause the elastomeric seal to become harder. As a result the valve velocity from contact with the valve seat to a stationary position will have a different velocity profile compared to the elastomeric seal before swelling or shrinkage.

Thus, the valve velocity correlates to the seal properties and the velocity data will improve the evaluation of the seal properties.

The hydraulic arrangement may comprise a clock for providing time such that the velocity can be calculated based on position data.

In an aspect, the hydraulic arrangement may be adapted for performing the method of evaluating seal properties of an elastomeric seal or plastic seal.

In an aspect, the hydraulic arrangement may comprise an actuator housing comprising a first piston chamber with a first piston separating the first piston chamber in a first upper cavity and a first lower cavity and having a first piston shaft configured to operate the valve element outside of the actuator housing.

This configuration enables precise control of the piston and thus of the valve actuated by the piston shaft, thereby the valve element can be moved with great precision while the position detection means measures the valve position with great precision.

The hydraulic liquid may be a hydraulic oil or water.

In an aspect, the hydraulic arrangement may comprise one or more linear actuators and/or one or more rotary actuators being configured for operating the valve element.

The hydraulic arrangement may comprise a linear actuator driving a rotary actuator, wherein the rotary actuator is coupled to a butterfly valve.

The hydraulic arrangement may comprise a rotary actuator driving a linear actuator.

The hydraulic arrangement may comprise rotary actuator coupled to a butterfly valve.

In an aspect, the position detection means may comprise
a magnet mechanically linked to the valve element, wherein actuation of the valve element causes actuation of the magnet along a magnet path; and
a plurality of magnetic sensors positioned to measure a magnetic field along the magnet path.

This embodiment of the position detection means enable detection of the valve element to a precision of about 10 to 100 μm.

The magnet is mechanically linked to the valve element such that the actuation of the magnet and the valve element may be directly correlated i.e., a 1 cm linear movement of the valve results in a 1 cm linear movement of the magnet. This would be the case where the magnet is connected to piston shaft actuating the valve element.

However, the hydraulic arrangement may comprise a linear actuator driving a rotary actuator driving a butterfly valve, which butterfly valve includes a valve element and valve seat.

In this case, the magnet may be connected to the linear actuator and thus the movement and position of the magnet does not correlate directly to the movement and the position and/or velocity of the valve element, however this can be calculated using basic mathematics. The reverse situation may also be possible.

There may be other embodiments of the mechanical link between the magnet and the valve element.

In an embodiment, the hydraulic arrangement may comprise a rotary actuator driving a butterfly valve, which butterfly valve includes a valve element and valve seat. In this case, the magnet is connected to an external part of the rotary actuator such as a part of the piston shaft of the rotary actuator, which part being external to a piston chamber of the rotary actuator. The magnet will then be actuated along a magnet path being curved or circle arced, and the magnetic sensors are positioned along the magnet path.

The magnet may be a permanent magnet.

In an aspect, one or more of the magnetic sensors of the plurality of magnetic sensors may be Hall sensors.

The Hall sensors provide sufficient precision for measuring the magnetic field and enable the position of the magnet to be determined.

In an aspect, the magnet path may be a substantially straight line, and the plurality of magnetic sensors include a series of magnetic sensors positioned along a substantially straight line parallel to the magnet path.

The magnet path being a straight line, and the magnet sensors positioned parallel to the magnet path simplifies the needed computation power required for calculating the magnet position and thus position and/or velocity of the valve element.

In an embodiment, the magnet may be incorporated in a magnet holder, which comprises a first aperture complementary to a support rod extending parallel to the first magnet path and through the first aperture to provide support and reduce play of the magnet. The embodiment will increase the precision of the magnet and thus the position of the valve element to a precision of 10-25 μm.

In an aspect, the magnet path may be a curve or circle arc, and the plurality of magnetic sensors include a series of magnetic sensors positioned in a curve or arc complementary to the magnet path.

In the embodiments where the magnet path is arched or curved there may be series of magnetic sensors along the curved or arched magnet path in order to acquire better data of the magnetic field.

An aspect of embodiments of the invention is achieved by a valve system comprising one or more hydraulic arrangements. The valve system comprises a common evaluation module adapted for receiving data from the one or more hydraulic arrangements and the common evaluation module comprises means for evaluating seal properties of the elastomeric seals or the plastic seals as a function of the stored valve initial contact positions.

The number of hydraulic arrangements may be 1, or 5, or 10, or 50, or 100, or more. Thus, the valve system will collect data from all the hydraulic arrangements, which may then be used for improving the evaluation of the individual seal properties of each elastomeric seal or each plastic seal.

The hydraulic arrangements may comprise a communication module adapted for wired or wireless communication with the valve system.

The valve system may comprise the means for performing the method of evaluating seal properties of an elastomeric seal or a plastic seal on a valve element or a valve seat.

### BRIEF DESCRIPTION

Some of the embodiments will be described in detail, with references to the following Figures, wherein like designations denote like members, wherein:

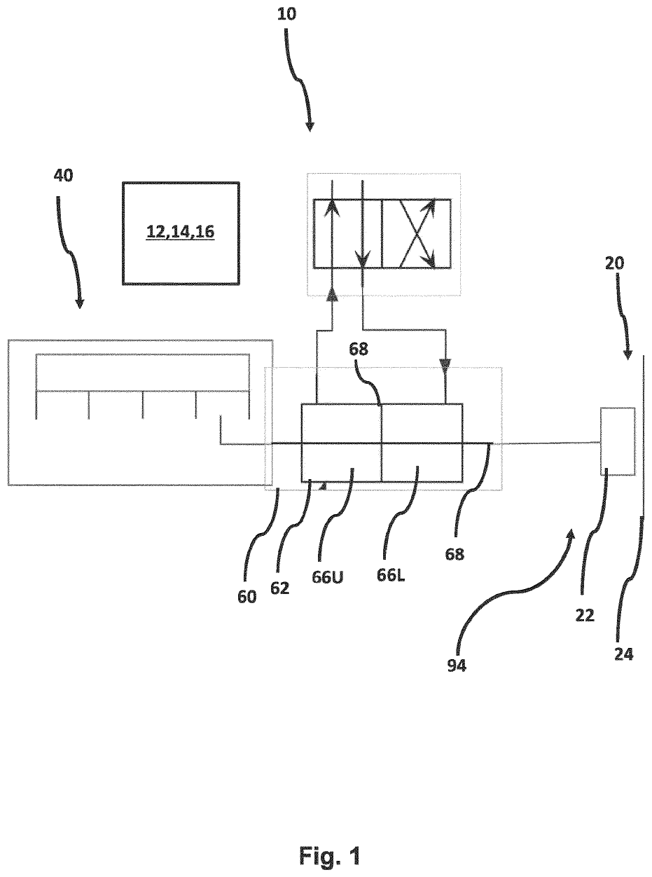

FIG. 1 illustrates a schematic of a hydraulic arrangement with position detection means;

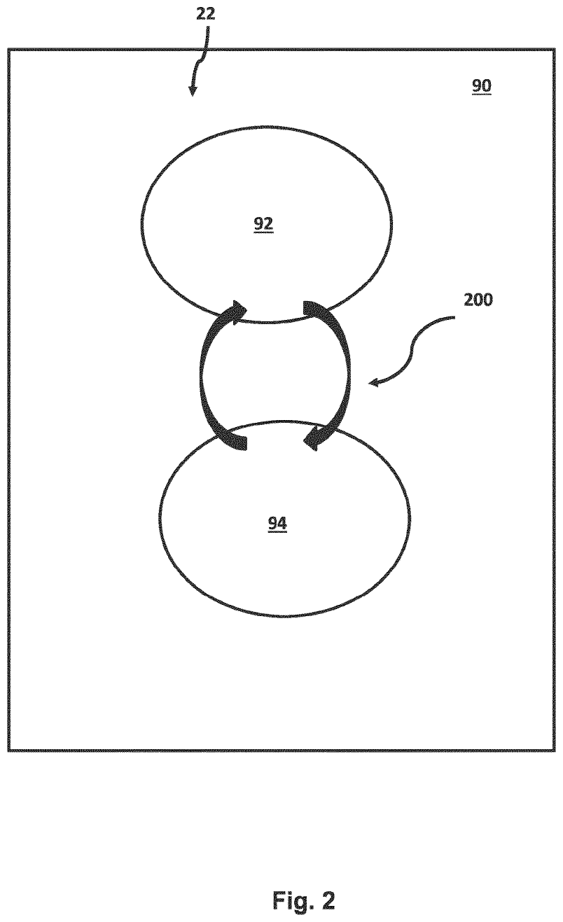

FIG. 2 illustrates a state diagram of a valve element being operated between a contact state and a non-contact state;

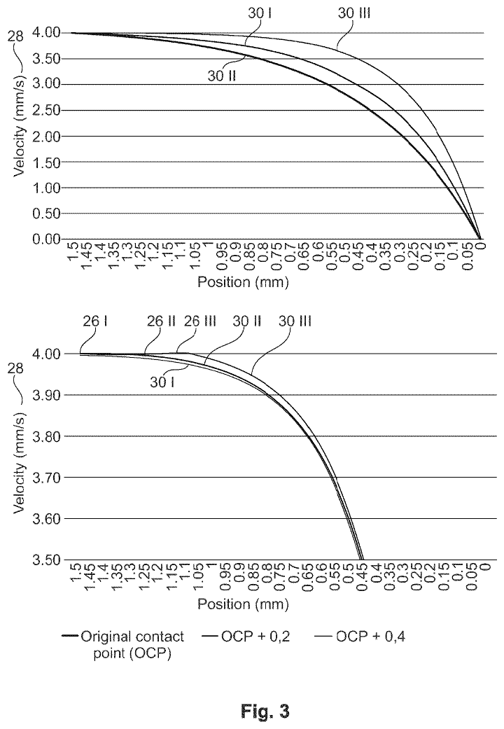

FIG. 3 illustrates two graphs with seals having different seal properties;

FIG. 4 illustrates a schematic of an embodiment of a hydraulic arrangement controlling two valves;

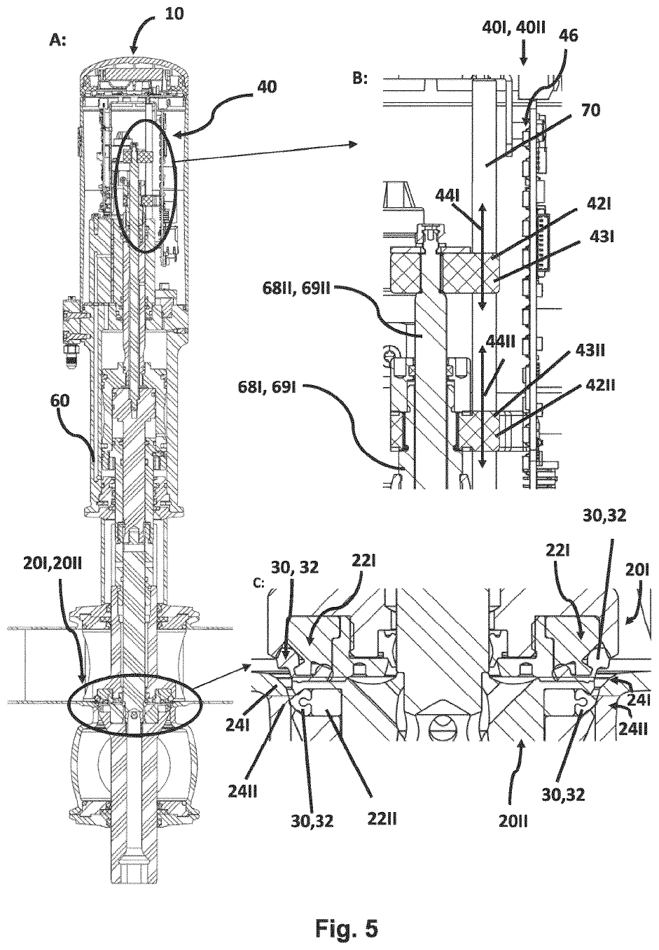

FIG. 5 illustrates a detailed view of the embodiment of a hydraulic arrangement controlling two valves;

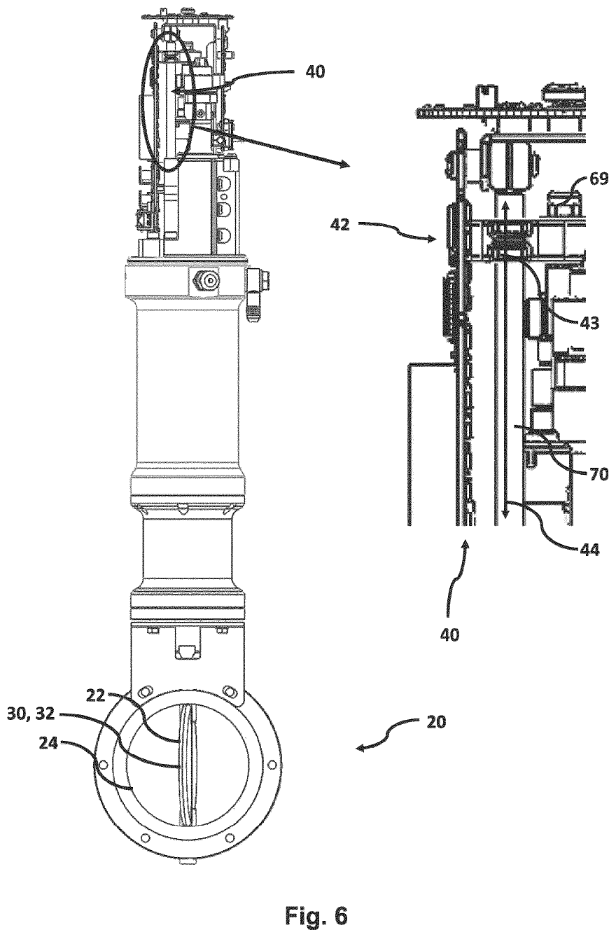

FIG. 6 illustrates a detailed view of an embodiment of a hydraulic arrangement controlling a butterfly valve;

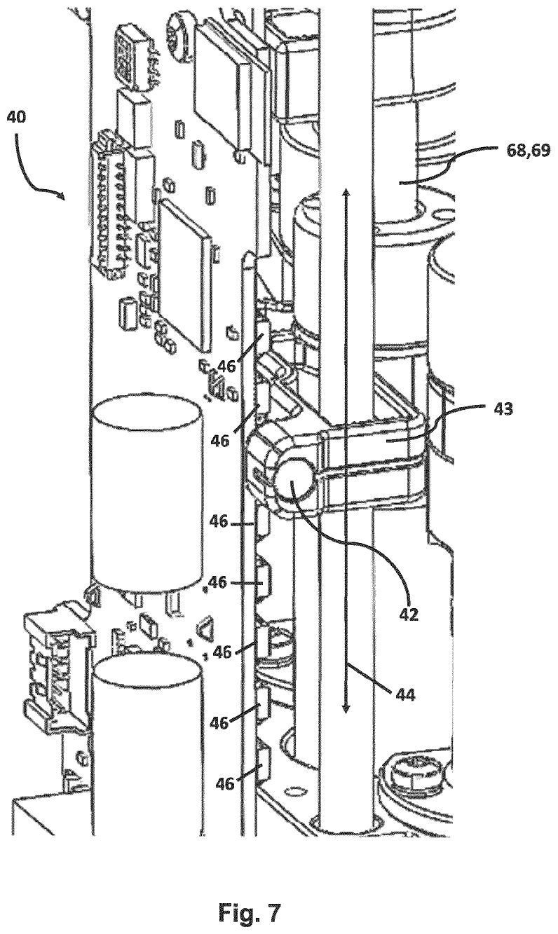

FIG. 7 illustrates a detailed view of position detection means comprising a magnet and magnetic sensors;

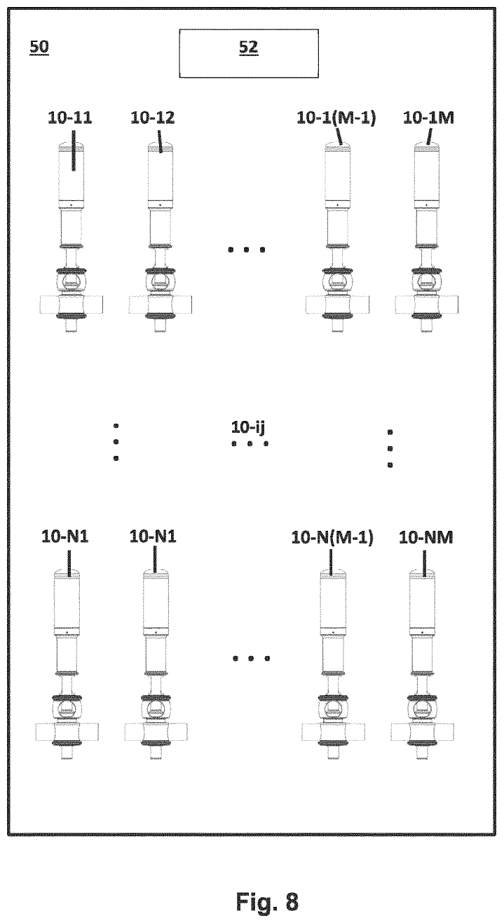

FIG. 8 illustrates a valve system; and

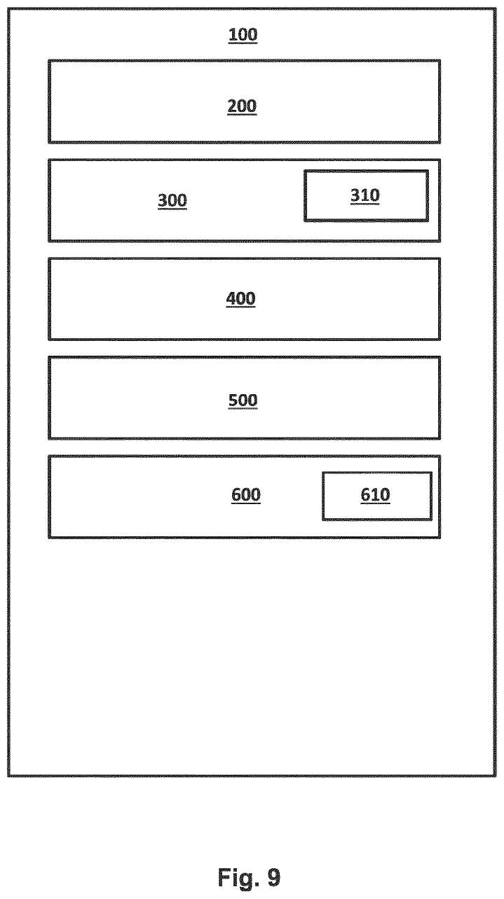

FIG. 9 illustrates a method of evaluating seal properties of an elastomeric seal or a plastic seal on a valve element or a valve seat.

| Item | Reference |
|---|---|
| Hydraulic arrangement | 10 |
| Evaluation module | 12 |
| Communication module | 14 |
| Computer-readable medium | 16 |
| Valve | 20 |
| Valve element | 22 |
| Valve seat | 24 |
| Valve initial contact position | 26 |
| Valve velocity | 28 |
| Elastomeric seal | 30 |
| Plastic seal | 32 |
| Position detection means | 40 |
| Magnet | 42 |
| Magnet holder | 43 |
| Magnet path | 44 |
| Magnetic sensor | 46 |
| Valve system | 50 |
| Common evaluation module | 52 |
| Actuator housing | 60 |
| Piston chamber | 62 |
| Piston | 64 |
| Upper cavity | 66U |
| Lower cavity | 66L |
| Piston shaft | 68 |
| Shaft end part | 69 |
| Support rod | 70 |
| Normal operation | 90 |
| Contact state | 92 |
| Non-contact state | 94 |
| Method | 100 |
| Changing | 200 |
| Measuring | 300 |
| Calculating | 310 |
| Storing | 400 |
| Repeating | 500 |
| Evaluating | 120 |
| Predicting | 610 |

### DETAILED DESCRIPTION

FIG. 1 illustrates a schematic of a hydraulic arrangement 10 with position detection means 40.

The hydraulic arrangement 10 comprises an actuator housing 60. The actuator housing 60 comprises a piston chamber 62 with a piston 64 separating the first piston chamber 62I in an upper cavity 66U and a lower cavity 66L and having a piston shaft 68I configured to operate the valve element 22 outside of the actuator housing 60. The shown solution is a linear actuator, but the invention will also work for a rotary actuator.

Hydraulic actuation of the piston 64 will cause the piston shaft 68 to be displaced. The piston shaft 68 is connected to a valve element 22 of a valve 20. The valve 20 further comprises a valve seat 24 which is complementary to the valve element 22. The valve 20 further comprises a (not shown) seal, which is either an elastomeric seal 30 or a plastic seal 32. The elastomeric seal 30 or the plastic seal 32 is positioned on the valve element 22 or the valve seat 24 and viewed as being part of the respective valve element 22 or valve seat 24.

The actuation will cause the valve element 22 to change state between a
a contact state 92, where the valve element 22 is in contact with the valve seat 24, and
a non-contact state 94, where the valve element 22 is not in contact with the valve seat 24.

The shown embodiment is presently in the non-contact state 94.

The position detection means 40 adapted for measuring a position of the valve element 22 relative to the valve seat 24 including a valve initial contact position 26, where the elastomeric seal 30 or the plastic seal 32 is in contact with the valve element 22 or the valve seat 24.

The piston shaft 68 comprises a shaft end part, which shaft end part extend out of the actuator housing 60 in a direction opposite to the valve 20.

The position detection means 40 comprises means for measuring a position of the shaft end part.

This may be done using resistivity, where the shaft end part is in contact with resistor and a voltage is measured across. The position of the shaft end part can then be calculated as a function of the voltage, and since the second shaft part will move in unison with the valve element 42, the position of the valve element 42 can be calculated.

A magnet 42 may be connected to the shaft end part and thus be displaceable along a magnet path 44. The position detection means 40 may comprise a plurality of magnetic sensors 46 along the magnet path 44. Thereby, the position of the magnet 42 can be calculated as a function of the measured magnetic field. The magnet 42 will in this embodiment move in unison with the valve element 42 and thus the position of the valve element 42 can be calculated.

Thereby, the hydraulic arrangement 10 can detect the valve initial contact position 26, where the elastomeric seal 30 or the plastic seal 32 is in contact with the valve element 22 or the valve seat 24. The hydraulic arrangement 10 may also use the valve position data for calculating and/or measuring a valve velocity 28 from contact with the valve seat 24 to a stationary position of the valve element 22.

In the shown embodiment, the hydraulic arrangement 10 further comprises an evaluation module 12 comprising a computer-readable medium 16 for storing at least the valve initial contact position 26 and means for evaluating seal properties of the elastomer as a function of the stored valve initial contact positions 26. FIG. 3 shows examples of different valves velocities as a function of seal property.

In the shown embodiment, the hydraulic arrangement 10 further comprises a communication module 14 adapted for wired or wireless communication with an external evaluation module adapted for evaluating seal properties of the elastomeric seal 30 or the plastic seal 32 as a function of the stored valve initial contact positions 26.

The valve initial contact position 26 and the valve velocity can be measured during normal operation of the valve 20, i.e., the hydraulic arrangement 10 can evaluate the seal properties using valve position data and valve velocity data stored during normal use of the hydraulic arrangement 10.

FIG. 2 illustrates a state diagram of a valve element 22 being operated between a contact state 92 and a non-contact state 94.

The valve element 22 is operated between
a contact state 92, where the valve element 22 is in contact with a valve seat 24, and
a non-contact state 94, where valve element 22 is not in contact with the valve seat 24.

A hydraulic arrangement 10 will, when changing states between the non-contact state 94 to the contact state 92, perform the method or at least part of the method steps according to one or more of claims 1 to 6. The step of evaluation 600 and storing 400 may be performed on an external computer or server, however in some embodiments the hydraulic arrangement 10 can perform all the steps of the method of evaluating seal properties of an elastomeric seal or a plastic seal on a valve element or a valve seat.

The step of changing 200 state is performed during normal operation of the hydraulic arrangement 10 and thus it is not required to have operation downtime relative to check on a seal 30, 32 since the seal 30, 32 is evaluated during use.

FIG. 3 illustrates two graphs (A, B) with seals 30, 32 having different seal properties. The graphs are simulations of possible data based on elastomeric seal 30.

Graph A shows a valve velocity 28 as a function of valve position for elastomeric seals 30I, 30II, 30III. The elastomeric seal 30I shows a new, without wear elastomeric seal 30I. The position values are relative values.

If this elastomeric seal 30I becomes softer over time, i.e., shore is reduced, then the valve velocity 28 will change towards the valve velocity 28 of the elastomeric seal 30III since the elastomeric seal 30III will at valve initial contact position 26 provide less resistance and thus the velocity change will be smaller compared to elastomeric seal 30I.

If this elastomeric seal 30I becomes harder over time, i.e., shore is increased, then the valve velocity 28 will change towards the valve velocity 28 of the elastomeric seal 30II since the elastomeric seal 30II will at valve initial contact position 26 provide more resistance and thus the velocity change will be smaller compared to elastomeric seal 30I.

Thus, properties of the elastomeric seal 30I can be deduced by comparing valve velocities 28 of the same seal measured over time.

Graph B shows a valve velocity 28 as a function of valve position for elastomeric seals 30I, 30II, 30III. The elastomeric seal 30I shows a new, without wear elastomeric seal 30I. The position values are relative values.

The graph B shows how abrasion of an elastomeric seal 30I will change the graph. The elastomeric seal 30I is a new elastomeric seal with no material abrasion due to wear. The elastomeric seal 30II has wear, and as a result a valve initial contact position 26 is displaced relative to the elastomeric seal 30I.

The elastomeric seal 30II has even more wear, and as a result the valve initial contact position 26 is displaced relative to the elastomeric seals 30I and 30II.

The above-mentioned displacement could also be due to shrinkage, however it would then be possible to recognize that this displacement is due to shrinkage by the change in velocity as the valve element 22 moves towards a standstill.

FIG. 4 illustrates a schematic of an embodiment of a hydraulic arrangement 10 controlling two valves 20I, 20II. A detailed embodiment of the hydraulic arrangement 10 is shown in FIG. 5.

Each valve 20I, 20II comprises a valve element 22I, 22II and a complementary valve seat 24I, 24II. The first valve element 22I or the first valve seat 24I comprises an elastomeric seal 30 or a plastic seal 32. The second valve element 22II or the second valve seat 24II comprises an elastomeric seal 30 or a plastic seal 32.

The hydraulic arrangement 10 comprises an actuator housing 60 comprising a first piston chamber 62I with a first piston 64I separating the first piston chamber 62I in a first upper cavity 66IU and a first lower cavity 66IL and having a first piston shaft 68I configured to operate the first valve element 22I outside of the actuator housing 60.

The actuator housing 60 further comprises a second piston chamber 62II with a second piston 64II separating the second piston chamber 62II in a second upper cavity 66IIU and a second lower cavity 66IIL and having a second piston shaft 68II configured to operate the valve element 22 outside of the actuator housing 60.

The second piston shaft 68II is extending through the first piston shaft 68I. Each piston shaft 68I, 68II comprises a shaft end part 69I, 69II extending out of the actuator housing 60 in a direction opposite to the valves 20I, 20II.

The hydraulic arrangement 10 further comprises a first position detection means 40I comprising a first magnet 42I mechanically linked to the first shaft end part 69I and thus to the first valve element 22I, wherein actuation of the first valve element 22I causes actuation of the first magnet 42I along a first magnet path 44I.

The hydraulic arrangement 10 further comprises a plurality of magnetic sensors 46, two is shown however there will in most cases be at least three magnetic sensors 46. The plurality of magnetic sensors 46 are positioned to measure a magnetic field along the first magnet path 44I. Thereby, the position of the first magnet 42I can be determined since the first magnet 42I is directly connected to the first valve element 22I by the piston shaft 68I, then the position of the first valve element 22I can be determined.

Thus, the first position detection means 40I is capable of measuring the position of the first valve element 22I relative to the first valve seat 24I, including a valve initial contact position 26, where the elastomeric seal 30 or the plastic seal 32 make contact with the first valve element 22I or the first valve seat 24I.

The hydraulic arrangement 10 further comprises a second position detection means 40II comprising a second magnet 42II mechanically linked to the second shaft end part 69II and thus to the second valve element 22II, wherein actuation of the second valve element 22II causes actuation of the second magnet 42II along a second magnet path 44II.

The plurality of magnetic sensors 46 are also positioned to measure a magnetic field along the second magnet path 44II. Thereby, the position of the first magnet 42I can be determined since the second magnet 42II is directly connected to the second valve element 22II by the second piston shaft 68II, then the position of the second valve element 22II can be determined.

Thus, the second position detection means 40II is capable of measuring the position of the second valve element 22II relative to the second valve seat 24II including a valve initial contact position 26, where the elastomeric seal 30 or the plastic seal 32 make contact with the second valve element 22II or the second valve seat 24II.

FIG. 5 illustrates a detailed view of the embodiment of a hydraulic arrangement 10 controlling two valves 20I, 20II. The hydraulic arrangement 10 enables mixing of two liquids. The functioning of the hydraulic arrangement 10 is described in greater detail in EP3374679.

The embodiment comprises an actuator housing 60 as illustrated in FIG. 4, however this will not be discussed in detail.

The present embodiment has additional features enabling the hydraulic arrangement 10 to measure the position and valve velocity of valve elements 22I, 22II of two valves 20I, 22II.

Each valve 20I, 20II comprises a valve element 22I, 22II and a complementary valve seat 24I, 24II. The first valve element 22I comprises an elastomeric seal 30 or a plastic seal 32. The second valve element 22II comprises an elastomeric seal 30 or a plastic seal 32.

A first piston shaft 68I is connected to the first valve element 22I and a second piston shaft 68II is connected to the second valve element 22II as illustrated in FIG. 4. The second piston shaft 68II extend through the first piston shaft 68I.

The first and second piston shaft 68I, 68II comprises a first and second shaft end part 69I, 69II, which shaft end parts 69I, 69II extend out of the actuator housing 60 in a direction opposite to the valves 20I, 20II.

The hydraulic arrangement 10 further comprises a first position detection means 40I comprising a first magnet 42I mechanically linked to the first shaft end part 69I and thus to the first valve element 22I, wherein actuation of the first valve element 22I causes actuation of the first magnet 42I along a first magnet path 44I.

The first magnet 42I is incorporated in a first magnet holder 43I, which comprises a first aperture complementary to a support rod 70 extending parallel to the first magnet path 44I and through the first aperture to provide support and reduce play of the first magnet 42I.

The hydraulic arrangement 10 further comprises a plurality of magnetic sensors 46. The plurality of magnetic sensors 46 are positioned to measure a magnetic field along the first magnet path 44I. Thereby, the position of the first magnet 42I can be determined since the first magnet 42I is directly connected to the first valve element 22I by the piston shaft 68I, then the position of the first valve element 22I can be determined.

Thus, the first position detection means 40I is capable of measuring the position of the first valve element 22I relative to the first valve seat 24I including a valve initial contact position 26, where the elastomeric seal 30 or the plastic seal 32 makes contact with the first valve element 22I or the first valve seat 24I.

The hydraulic arrangement 10 further comprises a second position detection means 40II comprising a second magnet 42II mechanically linked to the second shaft end part 69II and thus to the second valve element 22II, wherein actuation of the second valve element 22II causes actuation of the second magnet 42II along a second magnet path 44II.

The second magnet 42II is incorporated in a second magnet holder 43II, which comprises a second aperture complementary to the support rod 70 extending parallel to the first magnet path 44I and the second magnet path 44II and through the second aperture to provide support and reduce play of the second magnet 42II.

Thus, the second position detection means 40II is capable of measuring the position of the second valve element 22II relative to the second valve seat 24II including a valve initial contact position 26, where the elastomeric seal 30 or the plastic seal 32 makes contact with the second valve element 22II or the second valve seat 24II.

FIG. 6 illustrates a detailed view of an embodiment of a hydraulic arrangement 10 controlling a butterfly valve 20. The position and valve velocity of the butterfly valve 20 is determined as described in the earlier described embodiments.

The butterfly valve 20 comprises a valve element 22 with an elastomeric seal 30 or plastic seal 32 and a complementary valve seat 24. The hydraulic arrangement 10 comprises a linear actuator actuating a rotary actuator, which rotary actuator actuates the butterfly valve 20.

The linear actuator comprises a shaft end part 69 extending in a direction opposite to the butterfly valve 20.

The hydraulic arrangement 10 further comprises a position detection means 40 comprising a magnet 42 mechanically linked to the shaft end part 69 and thus to the valve element 22, wherein actuation of the valve element 22 causes actuation of the magnet 42 along a magnet path 44. The position of the magnet 42 is mechanically linked to the position butterfly valve 20 through the linear actuator and rotary actuator such that there is a relation between the position and velocity of the magnet 42 along the magnet path 44 and the position and valve velocity of the butterfly valve 20.

The magnet 42 is incorporated in a magnet holder 43, which comprises an aperture complementary to a support rod 70 extending parallel to the magnet path 44 and through the aperture to provide support and reduce play of the magnet 42 when moving along the magnet path 44.

The hydraulic arrangement 10 further comprises a plurality of magnetic sensors 46. The plurality of magnetic sensors 46 are positioned to measure a magnetic field along the magnet path 44I. Thereby, the position of the magnet 42I can be determined and since the magnet 42I is connected to the valve element 22 by the shaft end part 69, then the position of the valve element 22I can be determined.

Thus, the position detection means 40 is capable of measuring the position of the valve element 22 relative to the valve seat 24 including a valve initial contact position 26, where the elastomeric seal 30 or the plastic seal 32 makes contact the valve seat 24.

FIG. 7 illustrates a detailed view of position detection means 40 comprising a magnet 42 and magnetic sensors 46. The shown embodiment could be used in the embodiments shown in FIG. 5 or 6 or other embodiments of a hydraulic arrangement 10

A position detection means 40 comprises a magnet 42 mechanically linked to the shaft end part 69 and thus to a valve element 22, wherein actuation of the valve element 22 causes actuation of the magnet 42 along a magnet path 44. The position of the magnet 42 is thus mechanically linked to the position of the valve element 22 such that there is a relation between the position and velocity of the magnet 42 along the magnet path 44 and the position and valve velocity of the valve element 22.

The magnet 42 is incorporated in a magnet holder 43, which comprises an aperture complementary to a support rod 70 extending parallel to the magnet path 44 and through the aperture to provide support and reduce play of the magnet 42 when moving along the magnet path 44.

The hydraulic arrangement 10 further comprises a plurality of magnetic sensors 46. The plurality of magnetic sensors 46 are positioned to measure a magnetic field along the magnet path 44. Thereby, the position of the magnet 42 can be determined and since the magnet 42 is connected to the valve element 22 by the shaft end part 69, then the position of the valve element 22 can be determined.

Thus, the position detection means 40 is capable of measuring the position of the valve element 22 relative to the valve seat 24 including a valve initial contact position 26, where the elastomeric seal 30 or the plastic seal 32 makes contact the valve seat 24.

FIG. 8 illustrates a valve system 50 comprising N times M hydraulic arrangements 10-11, . . . , 10-NM, which may include one or more of the previous described hydraulic arrangements 10 such as the embodiments disclosed in FIG. 5 and/or FIG. 6.

The valve system 50 comprises a common evaluation module 52 adapted for receiving data from the one or more hydraulic arrangements 10-11, . . . , 10-NM and the common evaluation module 52 comprises means for evaluating seal properties of the elastomeric seals 30 or the plastic seals 32 as a function of the stored valve initial contact positions 26. Thereby a production can be surveyed while the valve system 50 is running during normal operation.

FIG. 9 illustrates a method 100 of evaluating seal properties of an elastomeric seal 30 or a plastic seal 32 on a valve element 22 or a valve seat 24. The valve element 22 is operated by a hydraulic arrangement 10, wherein the valve element 22 is operated between
a contact state 92, where the valve element 22 is in contact with the valve seat 24, and
a non-contact state 94, where the valve element 22 is not in contact with the valve seat 24.

In embodiments, the method 100 comprises steps of
changing 200 state from a non-contact state 94 to a contact state 92,
measuring 300 a valve initial contact position 26 at contact with the valve seat 24, where the elastomeric seal 30 or the plastic seal 32 makes contact with the valve element 22 or the valve seat 24;
storing 400 the valve initial contact position 26 on a computer-readable medium 16,
repeating 500 the steps of changing 200, measuring 300 and storing 400, and
evaluating 600 seal properties of the elastomeric seal 30 or plastic seal 32 as a function of the stored valve initial contact positions (26).

The step of measuring 300 may include a valve velocity 28 from contact with the valve seat 24 to a stationary position of the valve element 22. The step of storing 400 may include storing the valve velocity 28 on a computer-readable medium 16, and the step of evaluating 120 may include evaluating seal properties of the elastomeric seal 30 or the plastic seal 32 as a function of the stored valve velocities 28.

In embodiments, the method 100 may be performed during normal operation 90 of the hydraulic arrangement 10.

The step of evaluating 120 may include a step of predicting 610 remaining operating time to a failure of the elastomeric seal 30 or plastic seal 32.

A magnet 40 may be mechanically linked to the valve element 22, wherein actuation of the valve element 22 causes actuation of the magnet 42 along a magnet path 44. The step of measuring 300 comprises a step of measuring 300 a magnetic field along the magnet path 42 and a step of calculating 310 the valve initial contact position 26 as a function of the magnetic field along the magnet path 42.

The step of calculating 310 may include calculating the valve velocity 28 as a function of the magnetic field along the magnet path 42.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A method of evaluating seal properties of an elastomeric seal or a plastic seal on a valve element or a valve seat, which valve element being operated by a hydraulic arrangement, wherein the valve element is operated between
a contact state, where the valve element is in contact with the valve seat, and
a non-contact state, where the valve element is not in contact with the valve seat,
wherein the method comprises,
changing state from a non-contact state to a contact state,
measuring a valve initial contact position at contact with the valve seat, where the elastomeric seal or the plastic seal makes contact with the valve element or the valve seat, and measuring a valve velocity of the valve element from contact with the valve seat to a stationary position of the valve element;
storing the valve initial contact position and the valve velocity on a computer-readable medium,
repeating the changing, measuring and storing, and
evaluating seal properties of the elastomeric seal or plastic seal as a function of the stored valve initial contact positions and the stored valve velocities.

2. (canceled)

3. The method according to claim 1, wherein the method is performed during normal operation of the hydraulic arrangement.

4. The method according to claim 1, wherein the step of evaluating includes a step of predicting remaining operating time until a failure of the elastomeric seal or plastic seal.

5. The method according to claim 1, wherein a magnet is mechanically linked to the valve element and wherein actuation of the valve element causes actuation of the magnet along a magnet path and wherein the step of measuring comprises;
a step of measuring a magnetic field along the magnet path; and
a step of calculating the valve initial contact position as a function of the magnetic field along the magnet path.

6. The method according to claim 4, wherein the step of calculating includes calculating the valve velocity as a function of the magnetic field along the magnet path.

7. A hydraulic arrangement comprising a valve with a valve element and a complementary valve seat, and an elastomeric seal or a plastic seal on the valve element or the valve seat, the valve element is operated between
a contact state, where the valve element is in contact with a valve seat, and
a non-contact state, where valve element is not in contact with the valve seat,
wherein the hydraulic arrangement further comprises
a position detection means—or position detector configured for measuring a position of the valve element relative to the valve seat, including a valve initial contact position, where the elastomeric seal or the plastic seal makes contact with the valve element or the valve seat, and the position detection means—or portion detector is configured for measuring a valve velocity from contact with the valve seat to a stationary position of the valve element;
wherein the hydraulic arrangement further comprises:
an evaluation module comprising a computer-readable medium for storing at least the valve initial contact position and the valve velocity and an evaluator or means for evaluating seal properties of the elastomer as a function of the stored valve initial contact positions and the stored valve velocity, and/or
a communication module configured for wired or wireless communication with an external evaluation module configured for evaluating seal properties of the elastomeric seal or the plastic seal as a function of the stored valve initial contact positions and valve velocity.

8. (canceled)

9. The hydraulic arrangement according to claim 7, wherein the hydraulic arrangement is configured for performing the method.

10. The hydraulic arrangement according to claim 6, wherein the hydraulic arrangement comprises:
an actuator housing comprising a first piston chamber with a first piston separating the first piston chamber in a first upper cavity and a first lower cavity and having a first piston shaft configured to operate the valve element outside of the actuator housing.

11. The hydraulic arrangement according to claim 6, wherein the hydraulic arrangement comprises one or more linear actuators and/or one or more rotary actuators being configured for operating the valve element.

12. The hydraulic arrangement according to claim 6, wherein the position detection means—or position detector comprise:
a magnet mechanically linked to the valve element, and wherein actuation of the valve element causes actuation of the magnet along a magnet path; and
a plurality of magnetic sensors positioned to measure a magnetic field along the magnet path.

13. The hydraulic arrangement according to claim 10, wherein one or more of the magnetic sensors of the plurality of magnetic sensors are Hall sensors.

14. The hydraulic arrangement according to claim 10, wherein
the magnet path is a substantially straight line, and the plurality of magnetic sensors include a series of magnetic sensors positioned along a substantially straight line parallel to the magnet path; or
the magnet path being a curve or circle arc, and the plurality of magnetic sensors include a series of magnetic sensors positioned in a curve or arc complementary to the magnet path.

15. A valve system comprising one or more hydraulic arrangements according to claim 6, wherein the valve system comprises a common evaluation module configured for receiving data from the one or more hydraulic arrangements and the common evaluation module comprises an evaluator or means for evaluating seal properties of the elastomeric seals or the plastic seals as a function of the stored valve initial contact positions.
